(19) United States
(12) Patent Application Publication
(10) Pub. No.: US 2013/0081144 A1
(43) Pub. Date: Mar. 28, 2013

(54) STORAGE DEVICE AND WRITING DEVICE

(71) Applicant: Toru KAMBAYASHI, Kanagawa (JP)

(72) Inventor: Toru KAMBAYASHI, Kanagawa (JP)

(73) Assignee: Kabushiki Kaisha Toshiba, Tokyo (JP)

(21) Appl. No.: 13/538,366

(22) Filed: Jun. 29, 2012

(30) Foreign Application Priority Data
Sep. 26, 2011 (JP) 2011-209291

(51) Int. Cl. G06F 21/24

(52) U.S. Cl. 726/27

(57) ABSTRACT

According to an embodiment, a storage device connected to an external device includes a data storage, a key storage, a random number generating unit, a random number storage, a random number transmitting unit, a data receiving unit, a calculating unit, a determining unit, and a storage control unit. The data receiving unit receives write data to be written into the data storage and first authentication information. The key storage stores a key. The calculating unit calculates second authentication information for data generated from the write data and the random number by using the key. The determining unit determines whether the first authentication information and the second authentication information are identical. The storage control unit stores the write data into the data storage when the first authentication information and the second authentication information are determined to be identical.

### CROSS-REFERENCE TO RELATED APPLICATION

This application is based upon and claims the benefit of priority from Japanese Patent Application No. 2011-209291, filed on Sep. 26, 2011; the entire contents of which are incorporated herein by reference.

### FIELD

Embodiments described herein relate generally to a storage device and a writing device.

### BACKGROUND

In implementing digital rights management (DRM) functions or the like in a device such as a PC, a tablet PC and a smart phone, it is important to ensure the security. If a system program of an operating system (OS) or a basic input/output system (BIOS) is tampered with, the DRM functions are useless. This is because it is possible to disable protection of data defined by the DRM and freely output, read or write data when a program implementing the DRM functions is running under such a system program.

It is important to prevent writing to disks and nonvolatile memories in order to prevent tampering with system programs. Attackers who tamper with system programs typically attempt to make persistently modify data and parameters of the system programs. This is because the system needs to be rebooted after the data and the parameters of the system programs are modified so as to disable the security of the system programs.

There is a technique called a reply protected memory block (RPMB) in an embedded MultiMediaCard (eMMC) memory as one technique for preventing modifications in a disk or a nonvolatile memory. In this technique, a host (writing device) and an eMMC share a key (shared key) in advance. When the host writes data into the eMMC, the host calculates a message authentication code (MAC) of the data to be written by using the shared key, adds the MAC to the data to be written and transmits the data to the eMMC. In turn, the eMMC calculates the MAC of the data to be therein written included in the received data by using the shared key that is held by the eMMC. Next, the eMMC compares the MAC in the received data with the value of the MAC resulted from the calculation by the eMMC. Only if the MAC values identical to each other, the eMMC writes the data to be written included in the received data at a specified address in the eMMC.

The MAC value for the data to be written can be calculated only by the host that shares the key with the eMMC. The eMMC thus can perform writing after confirming that the received data are data transmitted from an authenticated host by checking the MAC.

There is, however, a disadvantage in using the RPMB technique in preventing tampering with system programs. In the RPMB technique, update of system programs is not guaranteed. If the MAC value added to the data to be written is correct, the eMMC accepts the write request. Accordingly, if an image of system programs recorded in the eMMC has been saved, update of the system programs afterwards can be disabled by rewriting the image of the old system programs into the eMMC after the update.

### BRIEF DESCRIPTION OF THE DRAWINGS

FIG. 1 is a block diagram of a storage device according to a first embodiment;

FIG. 2 is a flowchart of operation of the storage device according to the first embodiment;

FIG. 3 is a block diagram of a writing device according to the first embodiment;

FIG. 4 is a flowchart of operation of the writing device according to the first embodiment;

FIG. 5 is a block diagram of a storage device according to a second embodiment;

FIG. 6 is a flowchart of operation of the storage device according to the second embodiment;

FIG. 7 is a block diagram of a writing device according to the second embodiment;

FIG. 8 is a flowchart of operation of the writing device according to the second embodiment; and

FIG. 9 is a diagram of a hardware configuration of the devices according to the first and second embodiments.

### DETAILED DESCRIPTION

According to an embodiment, a storage device connected to an external device includes a data storage, a key storage, a random number generating unit, a random number storage, a random number transmitting unit, a data receiving unit, a calculating unit, a determining unit, and a storage control unit. The data storage is configured to store data. The key storage is configured to store a key. The random number is configured to generating unit generate a random number. The random number is configured to storage store the random number generated by the random number generating unit. The random number transmitting unit is configured to transmit the random number to the external device. The data receiving unit is configured to receive write data to be written into the data storage and first authentication information from the external device. The calculating unit is configured to calculate second authentication information for data generated from the write data and the random number stored in the random number storage by using the key stored in the key storage. The determining unit is configured to determine whether the first authentication information and the second authentication information are identical. The storage control unit is configured to store the write data into the data storage when the first authentication information and the second authentication information are determined to be identical.

Embodiments of a storage device and a writing device will be described below in detail with reference to the accompanying drawings.

### First Embodiment

An information processing system according to the first embodiment includes a storage device that stores data and a writing device (host) that writes data into the storage device. As in the RPMB technique, the writing device and the storage device share a shared key in advance. In the information processing system according to the first embodiment, system programs are securely updated using random numbers generated by the storage device.

Outline of a process of writing data by the information processing system according to this embodiment will be described below. In the following, data to be written from the writing device into the storage device are referred to as write data. System programs as described above can be applied as the write data, but the write data are not limited thereto.

First, the storage device holds the generated random numbers therein. The writing device reads a random number from the storage device and calculates a MAC value that is authentication information on data that are combination of the random number and the write data. The writing device calculates the MAC value by using the shared key. The writing device transmits the write data with the MAC value to the storage device. The storage device combines the random number held therein with the received write data, and calculates the MAC value. If the MAC value is identical with the MAC value received from the writing device, the storage device records the write data at a specified address. If the MAC value is not identical, the storage device does not accept the write request from the writing device. According to this method, the MAC value of the write data is valid only once. Thus, even if the writing device holds data that was successfully written into the storage device and attempts to rewrite the data, the data cannot be written.

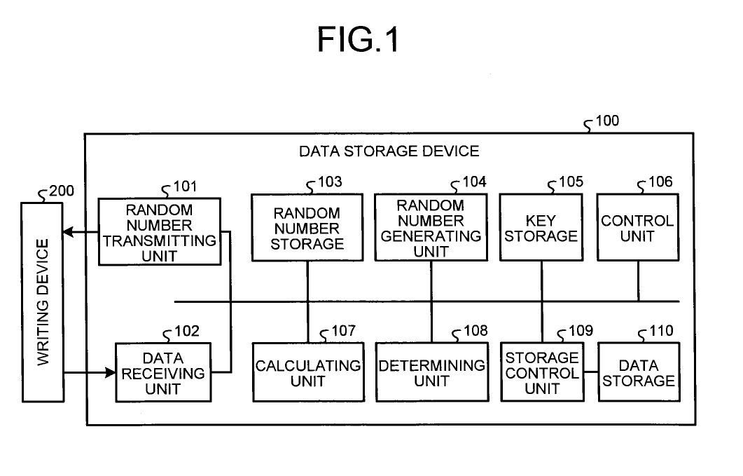

FIG. 1 is a block diagram illustrating an example of a configuration of a storage device 100 according to the first embodiment. The storage device 100 includes a data storage 110, a key storage 105, a random number generating unit 104, a random number storage 103, a random number transmitting unit 101, a data receiving unit 102, a calculating unit 107, a determining unit 108, a storage control unit 109 and a control unit 106.

The data storage 110 stores data (write data) written by a writing device 200. The data storage 110 may be a nonvolatile memory, for example.

The key storage 105 stores a shared key for calculating the MAC. The shared key is a key shared between the storage device 100 and the writing device 200.

The random number generating unit 104 generates a random number. The random number storage 103 stores the random number generated by the random number generating unit 104. The random number transmitting unit 101 outputs the random number stored by the random number storage 103 to outside of the storage device 100.

The data receiving unit 102 receives write data and a MAC value from outside of the storage device 100 and holds the received write data and MAC value.

The calculating unit 107 calculates the MAC value by using the shared key stored by the key storage 105 for data generated from the write data and the random number stored by the random number storage 103. Any algorithm that is conventionally used such as a method using hash functions (HMAC) can be used as an MAC algorithm used for calculation of the MAC value.

The determining unit 108 compares the MAC value calculated by the calculating unit 107 and the MAC value received by the data receiving unit 102, and determines whether or not the values are identical. Only when the values are identical, the determining unit 108 accepts the write data.

The storage control unit 109 records the write data accepted by the determining unit 108 in the data storage 110.

The control unit 106 controls the entire storage device 100.

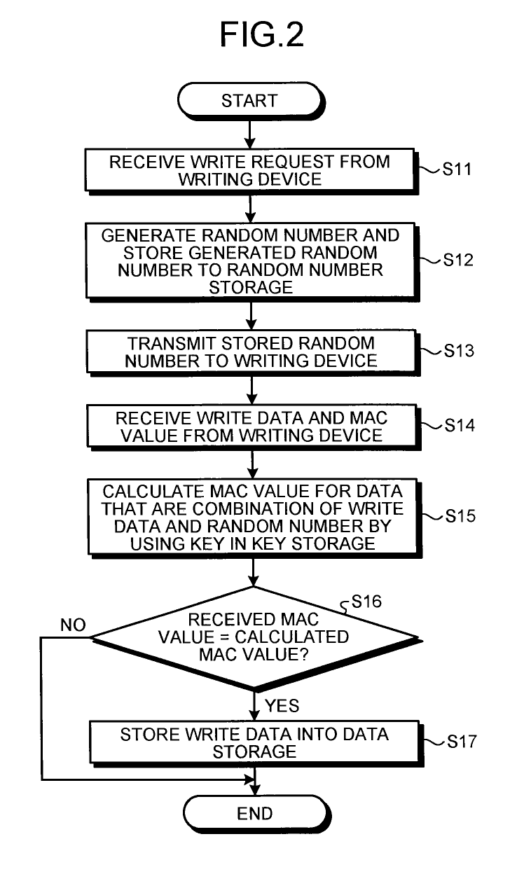

Next, a storage process performed by the storage device 100 according to the first embodiment having such a configuration will be described with reference to FIG. 2. FIG. 2 is a flowchart illustrating an example of operation of the storage device 100 according to the first embodiment.

The data receiving unit 102 receives a write request from the writing device 200 (step S11). The random number generating unit 104 generates a random number and stores the generated random number in the random number storage 103 (step S12). The random number transmitting unit 101 reads the random number stored in the random number storage 103 and transmits the read random number to the writing device 200 (step S13). The data receiving unit 102 receives the write data and the MAC value from the writing device 200 (step S14) and holds the write data and the MAC value.

Thereafter, the calculating unit 107 reads the write data from the data receiving unit 102. The calculating unit 107 also reads the random number from the random number storage 103 and reads the shared key for calculating the MAC from the key storage 105. The calculating unit 107 uses the random number and the shared key to calculate the MAC value M as in the following expression (1) (step S15):

M=MAC(K, D∥R) (1)

In the expression, K represents the shared key for calculation of the MAC, D represents the write data and R represents the random number value. D∥R represents data that are combination of D and R. In addition, MAC(K, D∥R) represents a function for calculating the MAC value for D∥R. The MAC value obtained by this function is represented by M.

Note that D∥R corresponds to the data generated from the write data D and the random number R. The data generated from the write data D and the random number R are not limited to data that are combination of D and R.

Next, the determining unit 108 reads the MAC value M from the calculating unit 107 and also reads the MAC value (hereinafter referred to as a MAC value M′) from the data receiving unit 102. The determining unit 108 then compares the read M and M′, and determines whether or not the values are identical (step S16).

If M and M′ are not identical (No in step S16), the determining unit 108 does not accept the write data. In this case, the storage device 100 terminates the operation. If M and M′ are identical (Yes in step S16), on the other hand, the determining unit 108 accepts the write data. In this case, the storage control unit 109 reads the write data from the data receiving unit 102 and stores the write data in the data storage 110 (step S17).

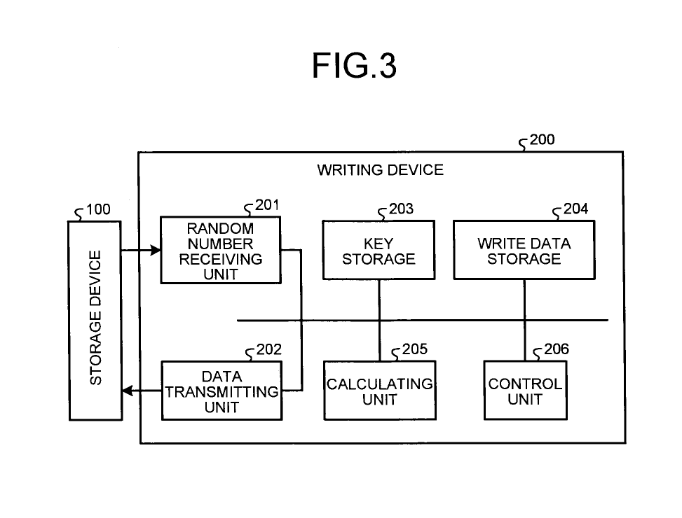

FIG. 3 is a block diagram illustrating an example of a configuration of the writing device 200 according to the first embodiment. The writing device 200 includes a key storage 203, a random number receiving unit 201, a calculating unit 205, a data transmitting unit 202, a write data storage 204 and a control unit 206.

The key storage 203 stores a shared key for calculating the MAC. The shared key is a key shared between the storage device 100 and the writing device 200.

The random number receiving unit 201 receives a random number from outside of the storage device 100. The calculating unit 205 calculates the MAC value for the data generated from the data received by the random number receiving unit 201 and the write data by using the shared key stored by the key storage 203.

The data transmitting unit 202 transmits the write data and the MAC value calculated by the calculating unit 205 to outside of the writing device 200.

The write data storage 204 holds the write data. The control unit 206 controls the entire writing device 200.

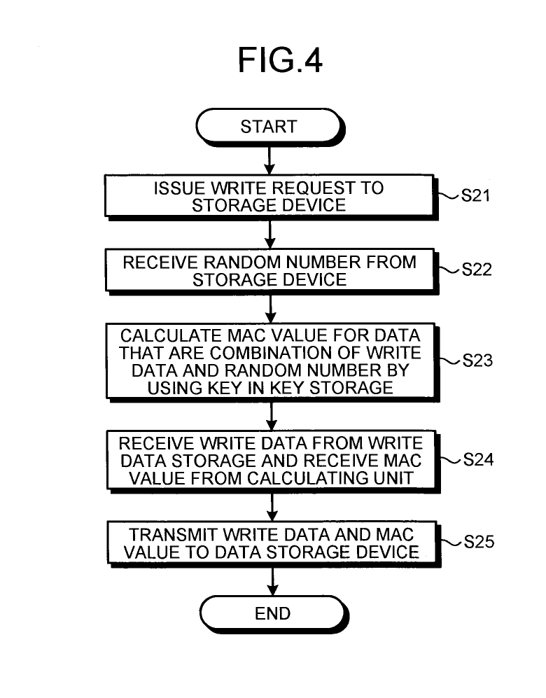

Next, a write process performed by the writing device 200 according to the first embodiment having such a configuration will be described with reference to FIG. 4. FIG. 4 is a flowchart illustrating an example of operation of the writing device 200 according to the first embodiment.

When writing the write data, the data transmitting unit 202 of the writing device 200 issues a write request to the storage device 100 (step S21). A random number is transmitted from the storage device 100 in response to the write request, and thus, the random number receiving unit 201 receives and holds the random number (step S22). The calculating unit 205 receives the write data from the write data storage 204 and also receives the random number from the random number receiving unit 201. The calculating unit 205 uses the shared key in the key storage 203 to calculate the MAC value M of data that are combination of the write data and the random number by using the expression (1) described above (step S23).

The data transmitting unit 202 then receives the write data D from the write data storage 204 and also receives the MAC value M from the calculating unit 205 (step S24). The data transmitting unit 202 transmits the write data D and the MAC value M to the storage device 100 (step S25).

As described above, in the information processing system according to the first embodiment, write data are stored in the storage device only when the write data are authenticated to be valid by the MAC value calculated by using the random number generated by the storage device. Since a random number is used, the MAC value of the write data is valid only once. Thus, even if the writing device holds data that have successfully been written into the storage device and attempts to rewrite the data again, the data cannot be written. Data such as system programs can therefore be updated securely.

### Second Embodiment

An information processing system according to the second embodiment updates system programs securely by using a version number. Outline of a process of writing data by the information processing system according to this embodiment will be described below.

A writing device transmits version information (version number) representing the version of write data such as system programs together with the write data to a storage device. In this regard, the writing device calculates a MAC value for data that are combination of the write data and the version number, and also transmits the MAC value with the write data and the version number. A shared key shared with the storage device is used for the calculation of the MAC value. The storage device holds a current version number. The storage device checks the MAC for the write data and the version number, and writes the data at a specified address only if the version number is strictly greater than the current version number held by the storage device. If the version number of the write data is not greater than the current version number, the storage device does not accept the write request from the writing device. In this method, the writing device does not need to receive the random number.

In the description above, the version number is assumed to strictly monotonically increase. In a case where “not old data” may be accepted, however, the storage device performs writing at a write address even when the version number accompanying the write data is the same as the version number of the write address. Furthermore, the version number may monotonically decrease. Alternatively, the version number as follows may be calculated according to a predetermined rule between the writing device and the storage device. For example, a function f is shared between the writing device and the storage device. The version number currently held by the storage device is represented by Vc. In this case, a next version number Vn is defined as Vn=f(Vc). The storage device accepts only write data accompanied by the version number Vn.

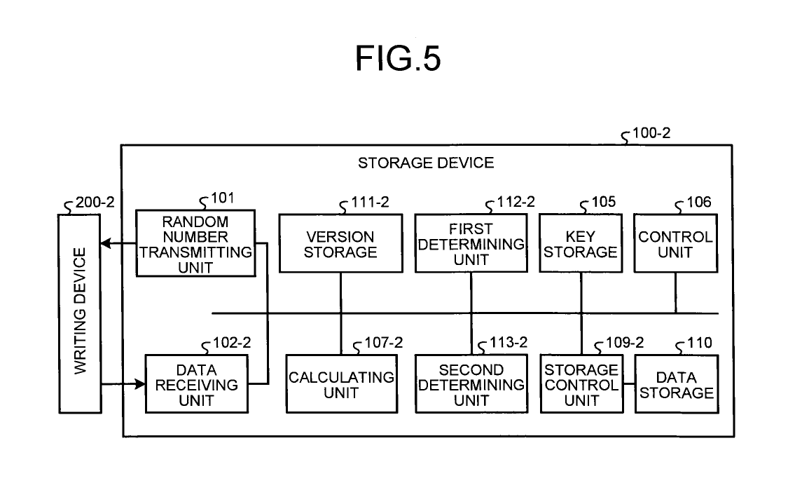

FIG. 5 is a block diagram illustrating an example of a configuration of a storage device 100-2 according to the second embodiment. As illustrated in FIG. 5, the storage device 100-2 includes a data storage 110, a key storage 105, a random number transmitting unit 101, a data receiving unit 102-2, a calculating unit 107-2, a version storage 111-2, a first determining unit 112-2, a second determining unit 113-2, a storage control unit 109-2 and a control unit 106. Components similar to those in the storage device 100 according to the first embodiment will be designated by the same reference numerals as in FIG. 1 and the description thereof will not be repeated here.

The version storage 111-2 stores the version number of write data. At a time point when no data are written, such as immediately after the storage device 100-2 is initialized, the version storage 111-2 stores the smallest version number such as 0.

The data receiving unit 102-2 receives write data, a version number and a MAC value from outside of the storage device 100-2 and holds these data.

The calculating unit 107-2 calculates a MAC value for data generated from the write data and the version number by using the shared key stored by the key storage 105.

The first determining unit 112-2 compares the MAC value calculated by the calculating unit 107-2 and the MAC value received by the data receiving unit 102-2, and determines whether or not the values are identical. Only when the values are identical, the first determining unit 112-2 accepts the write data.

The second determining unit 113-2 compares the version number received by the data receiving unit 102-2 and the version number stored by the version storage 111-2, and determines whether or not the former is a later version than the latter. When the version number strictly monotonically increases, the second determining unit 113-2 compares the version number received by the data receiving unit 102-2 and the version number stored by the version storage 111-2, and determines whether or not the former is greater than the latter. Only when the former is greater than the latter, the second determining unit 113-2 accepts the write data.

The storage control unit 109-2 records the write data into the data storage 110 only when both the first determining unit 112-2 and the second determining unit 113-2 have accepted the write data.

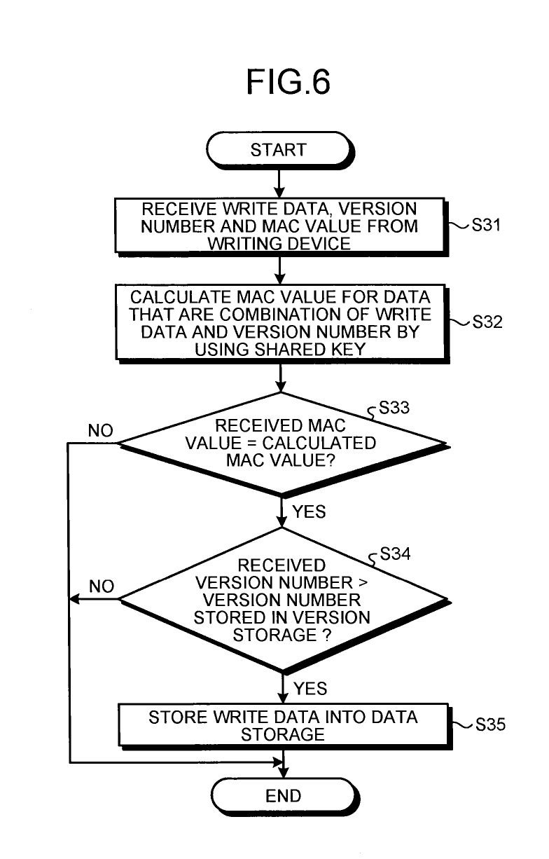

Next, a storage process performed by the storage device 100-2 according to the second embodiment having such a configuration will be described with reference to FIG. 6. FIG. 6 is a flowchart illustrating an example of operation of the storage device 100-2 according to the second embodiment.

First, the data receiving unit 102-2 receives write data, a version number and a MAC value from the writing device 200-2 (step S31). The calculating unit 107-2 receives the write data and the version number from the data receiving unit 102-2. The calculating unit 107-2 further reads out a shared key for calculating the MAC from the key storage 105. The calculating unit 107-2 calculates a MAC value for data that are combination of the write data and the version number by using the shared key (step S32). Specifically, the calculating unit 107-2 calculates the MAC value M as in the following expression (2) (step S32):

M=MAC(K, D∥Vn) (2)

In the expression, K represents the shared key stored by the key storage 105, D represents the write data, Vn represents the version number transmitted from the writing device 200-2 and held by the data receiving unit 102-2.

Next, the first determining unit 112-2 reads the MAC value M′ transmitted from the writing device 200-2 and held by the data receiving unit 102-2. The first determining unit 112-2 compares M and M′, and determines whether or not the values are identical (step S33). If the values are identical (Yes in step S33), the first determining unit 112-2 accepts the write data. If the values are not identical (No in step S33), the storage device 100-2 discards the write data and terminates the operation.

If the first determining unit 112-2 has accepted the write data, the second determining unit 113-2 reads the version number Vc from the version storage 111-2. The second determining unit 113-2 also reads the version number Vn held by the data receiving unit 102-2. The second determining unit 113-2 compares Vn and Vc, and determines whether Vn is greater than Vc (step S34).

If Vn is not greater than Vc (No in step S34), the second determining unit 113-2 does not accept the write data. In this case, the write data in the data receiving unit 102-2 are discarded and the storage device 100-2 terminates the operation.

If Vn is greater than Vc (Vn>Vc) (Yes in step S34), the second determining unit 113-2 accepts the write data. If both of the first determining unit 112-2 and the second determining unit 113-2 have accepted the data, the storage control unit 109-2 reads the write data from the data receiving unit 102-2 and records the write data into the data storage 110 (step S35).

The storage control unit 109-2 reads the version number held by the data receiving unit 102-2, and updates the version number stored by the version storage 111-2 by writing the version number from the data receiving unit 102-2 thereover. In updating a system program, for example, the version number of the system program is stored in advance in the version storage 111-2. It is thus possible to effectively prevent rollback of the system program.

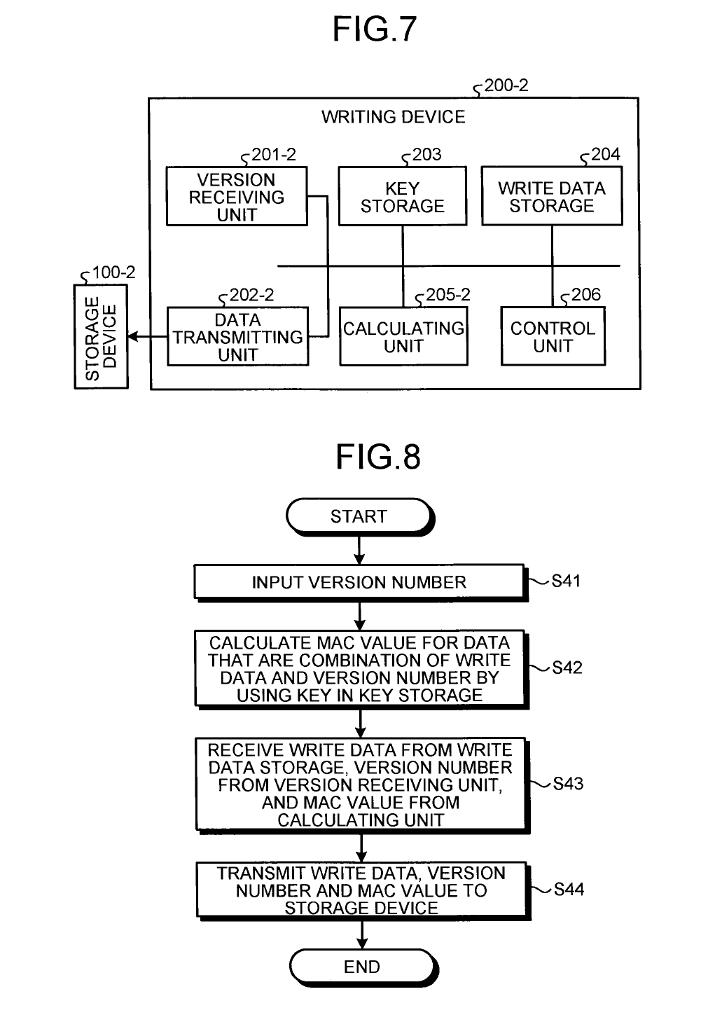

FIG. 7 is a block diagram illustrating an example of a configuration of the writing device 200-2 according to the second embodiment. The writing device 200-2 includes a key storage 203, a version receiving unit 201-2, a calculating unit 205-2, a data transmitting unit 202-2, a write data storage 204 and a control unit 206. Components similar to those in the writing device 200 according to the first embodiment will be designated by the same reference numerals as in FIG. 3 and the description thereof will not be repeated here.

The version receiving unit 201-2 receives input of the version number of write data and holds the version number. The calculating unit 205-2 calculates a MAC value for data generated from the write data and the input version number by using a shared key stored by the key storage 203.

The data transmitting unit 202-2 transmits the write data, the version number and the MAC value calculated by the calculating unit 205-2 to outside of the writing device 200-2.

Next, a write process performed by the writing device 200-2 according to the second embodiment having such a configuration will be described with reference to FIG. 8. FIG. 8 is a flowchart illustrating an example of operation of the writing device 200-2 according to the second embodiment.

First, the version receiving unit 201-2 receives input of the version number (step S41). A version number that is greater than the version number that was written last to the storage device 100-2 to write to is selected as the version number to be input.

The calculating unit 205-2 receives write data D from the write data storage 204 and receives the version number Vn from the version receiving unit 201-2. The calculating unit 205-2 calculates a MAC value M of data that are combination of the write data and the version number by using a shared key K in the key storage 105 as in the expression (2) described above (step S42).

The data transmitting unit 202-2 then receives the write data D from the write data storage 204, receives the version number Vn from the version receiving unit 201-2, and receives the MAC value M from the calculating unit 205-2 (step S43). The data transmitting unit 202-2 transmits the write data D, the version number Vn and the MAC value M to the storage device (step S44).

As described above, in the information processing system according to the second embodiment, write data are stored in the storage device only when the version number of the write data is greater than that of data already written. Even if the writing device holds data that have successfully been written to the storage device and attempts to rewrite the data, the data cannot be written because the version number thereof is not greater than the current version number. Data such as system programs can therefore be updated securely.

Herein, the version number is a numerical value, and there is a trivial magnitude relation (or, a magnitude relation that can be apparently understood) between two versions. When a certain version number V1 is smaller than another version number V2, the version number V2 may be a “later” version than the version number V1. The version number is typically an element of a totally-ordered set. The definition of a totally-ordered set is described in “Encyclopedic Dictionary of Mathematics, Third Edition” edited by Mathematical Society of Japan, For example. The order relation of the version numbers in the totally-ordered set is represented by ≦. That the version V2 is greater than the version V1 means that both V1≦V2 and V1≠V2 are satisfied.

As described above, the security in writing data into the storage device can be improved according to the first and second embodiments. For example, data update of a system program or the like to be stored in the storage device can be guaranteed.

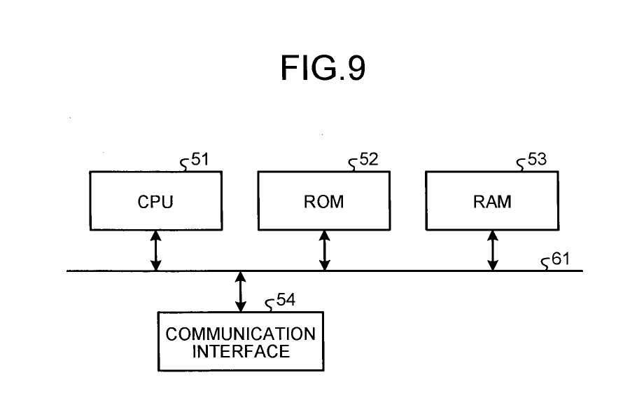

Next, a hardware configuration of devices (the storage device and the writing device) according to the first and second embodiments will be described with reference to FIG. 9. FIG. 9 is an explanatory diagram illustrating a hardware configuration of a device according to the first and second embodiments.

The device according to the first and second embodiments includes a control unit such as a central processing unit (CPU) 51, a storage such as a read only memory (ROM) 52 and a random access memory (RAM) 53, a communication interface 54 connected to a network for communication, and a bus 61 that connects these components.

Programs to be executed by the devices according to the first and second embodiments are embedded in the ROM 52 or the like in advance and provided therefrom.

The programs to be executed by the devices according to the first and second embodiments may also be recorded on a computer readable recording medium such as a compact disk read only memory (CD-ROM), a flexible disk (FD), a compact disk recordable (CD-R) and a digital versatile disk (DVD) in a form of a file that can be installed or executed, and provided as a computer program product.

Alternatively, the programs to be executed by the devices according to the first and second embodiments may be stored on a computer system connected to a network such as the Internet, and provided by being downloaded via the network. Still alternatively, the programs to be executed by the devices according to the first and second embodiments may be provided or distributed through a network such as the Internet.

The programs executed by the devices according to the first and second embodiments can make a computer system function as the respective units of the devices described above. In such a computer system, the CPU 51 can read the programs from the computer readable recording medium onto a main storage and execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device connected to an external device, the storage device comprising:
a data storage that stores data;
a key storage that stores a key;
a random number generating unit configured to generate a random number;
a random number storage that stores the random number generated by the random number generating unit;
a random number transmitting unit configured to transmit the random number to the external device;
a data receiving unit configured to receive write data to be written into the data storage and first authentication information from the external device;
a calculating unit configured to calculate, by using the key stored in the key storage, second authentication information for data generated from the write data and the random number stored in the random number storage;
a determining unit configured to determine whether the first authentication information and the second authentication information are identical; and
a storage control unit configured to store the write data into the data storage when the first authentication information and the second authentication information are determined to be identical.

2. A writing device connected to a storage device, the writing device comprising:
a key storage that stores a key;
a random number receiving unit configured to receive a random number from the storage device;
a calculating unit configured to calculate, by using the key stored in the key storage, authentication information for data generated from the random number and write data to be written into the storage device; and
a data transmitting unit configured to transmit the write data and the authentication information to the storage device.

3. A storage device connected to an external device, the storage device comprising:
a data storage that stores data;
a key storage that stores a key;
a version storage that stores first version information representing a version of the data;
a data receiving unit configured to receive
write data to be written into the data storage,
second version information representing a version of the write data and
first authentication information that is calculated on the basis of the second version information and the write data from the external device;
a calculating unit configured to calculate, by using the key stored in the key storage, second authentication information for data generated from the write data and the first version information;
a first determining unit configured to determine whether or not the first authentication information and the second authentication information are identical;
a second determining unit configured to determine whether or not a version represented by the second version information is a later version than a version represented by the first version information; and
a storage control unit configured to store the write data into the data storage when
the first authentication information and the second authentication information are determined to be identical and
the version represented by the second version information is determined to be a later version than the version represented by the first version information.

4. The storage device according to claim 3, wherein
the storage control unit, after storing the write data into the data storage, updates the first version information stored in the version storage with the second version information.

5. A writing device connected to a storage device, the writing device comprising:
a key storage stores a key;
a receiving unit configured to receive an input of version information representing a version of write data to be written into the storage device;
a calculating unit configured to calculate, by using the key stored in the key storage, authentication information for data generated from the version information and the write data; and
a data transmitting unit configured to transmit the write data, the version information, and the authentication information to the storage device.
